(19) United States
(12) Patent Application Publication
(10) Pub. No.: US 2026/0158884 A1
(43) Pub. Date: Jun. 11, 2026

(54) AERODYNAMIC MOVABLE TONNEAU COVER

(71) Applicant: FCA US LLC, Auburn Hills, MI (US)

(72) Inventors: Andrew L. Partin, Auburn Hills, MI (US); Aslam Adam, Auburn Hills, MI (US); Kivin Roberto-Lee Lewis, Auburn Hills, MI (US); Anthony L. Vincent, Auburn Hills, MI (US)

(21) Appl. No.: 18/974,872

(22) Filed: Dec. 10, 2024

(51) Int. Cl. B60J 7/04; B62D 35/00

(52) U.S. Cl. CPC B60J 7/041; B62D 35/001

(57) ABSTRACT

A tonneau system for a vehicle including a cargo bed includes a cover coupled to a frame being movable between a deployed position and a retracted position. The frame is movable between a horizontal position and an aerodynamic position. A leading edge of the frame is positioned at a higher elevation than a trailing edge of the frame when the frame is at the aerodynamic position. A first side panel includes a first portion pivotally coupled to the frame and a second portion pivotally coupled to the first portion. The first portion extends substantially parallel to the ground when the frame is at the horizontal position. The first portion extends upright when the frame is at the aerodynamic position to close an opening that forms between the frame and the vehicle when the frame is at the aerodynamic position.

### FIELD

The present disclosure relates to a tonneau cover for a vehicle. The tonneau cover may be moved between a horizontal position and a tilted position at which aerodynamic drag is reduced.

### BACKGROUND

This section provides background information related to the present disclosure which is not necessarily prior art.

Certain vehicles, such as pickup trucks, having a cargo bed are typically less aerodynamically efficient than passenger cars due to the size and shape of the vehicle cargo bed.

Pickup trucks have been equipped with tonneau covers or caps that extend across an upper surface of the truck bed walls and the tailgate to enclose the cargo bed and define a storage compartment. Some known designs include a fixed cap or manually foldable panels arranged in a trifold configuration. While some of these designs have increased the aerodynamic efficiency of the vehicle, opportunity exists for a greater reduction in vehicle drag.

A need in the art exists for a tonneau cover operable in a standard horizontal position as well as at an aerodynamically angled position.

### SUMMARY

This section provides a general summary of the disclosure and is not a comprehensive disclosure of its full scope or all of its features.

A tonneau system for a vehicle including a cargo bed includes a cover coupled to a frame being movable between a deployed position and a retracted position. The frame is movable between a horizontal position and an aerodynamic position. A leading edge of the frame is positioned at a higher elevation than a trailing edge of the frame when the frame is at the aerodynamic position. A first side panel includes a first portion pivotally coupled to the frame and a second portion pivotally coupled to the first portion. The first portion extends substantially parallel to the ground when the frame is at the horizontal position. The first portion extends upright when the frame is at the aerodynamic position to close an opening that forms between the frame and the vehicle when the frame is at the aerodynamic position.

A tonneau system for a vehicle includes a cover coupled to the frame being movable between a deployed position and a retracted position. The frame is movable between a horizontal position and an aerodynamic position where at the leading edge of the frame is positioned at an elevation higher than the trailing edge. Flexible first, second, and third side panels are compressed when the frame is at the horizontal position and extended when the frame is at the aerodynamic position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary perspective view of an exemplary vehicle equipped with a tonneau cover constructed in accordance with the teachings of the present disclosure;

FIG. 2 is a top view of the tonneau cover shown in an aerodynamic position as in FIG. 1;

FIG. 3 is a fragmentary perspective view of the tonneau cover shown in a horizontal position;

FIG. 4 is a fragmentary perspective view of the tonneau cover in an intermediate position between the horizontal and aerodynamic positions;

FIG. 5 is a fragmentary perspective of the tonneau cover including a first portion of the first side panel in an upright position while a second portion of the first side panel is at an intermediate position with the frame being at the aerodynamic position;

FIG. 6 is a fragmentary cross-sectional side view of the exemplary vehicle showing the second portion of the first side panel at a retracted position;

FIG. 7 is a fragmentary perspective view of an exemplary vehicle equipped with an alternate embodiment tonneau cover constructed in accordance with the teachings of the present disclosure;

FIG. 8 is another fragmentary perspective view of the exemplary vehicle equipped showing the tonneau cover of FIG. 7 in the aerodynamic position from a different angle; and

FIG. 9 is a fragmentary perspective view of an exemplary vehicle equipped with another alternate embodiment tonneau cover constructed in accordance with the teachings of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

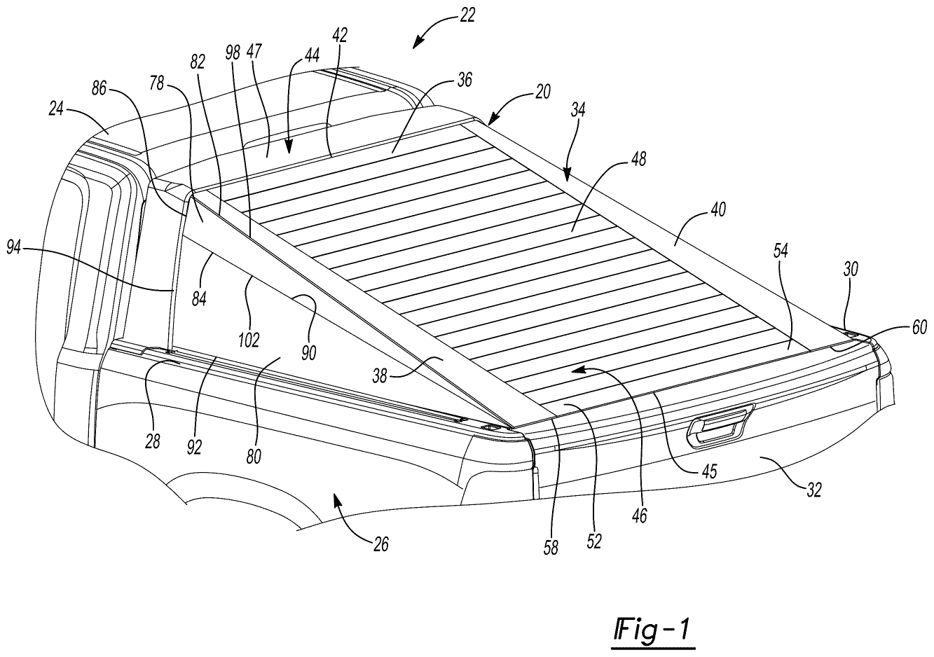

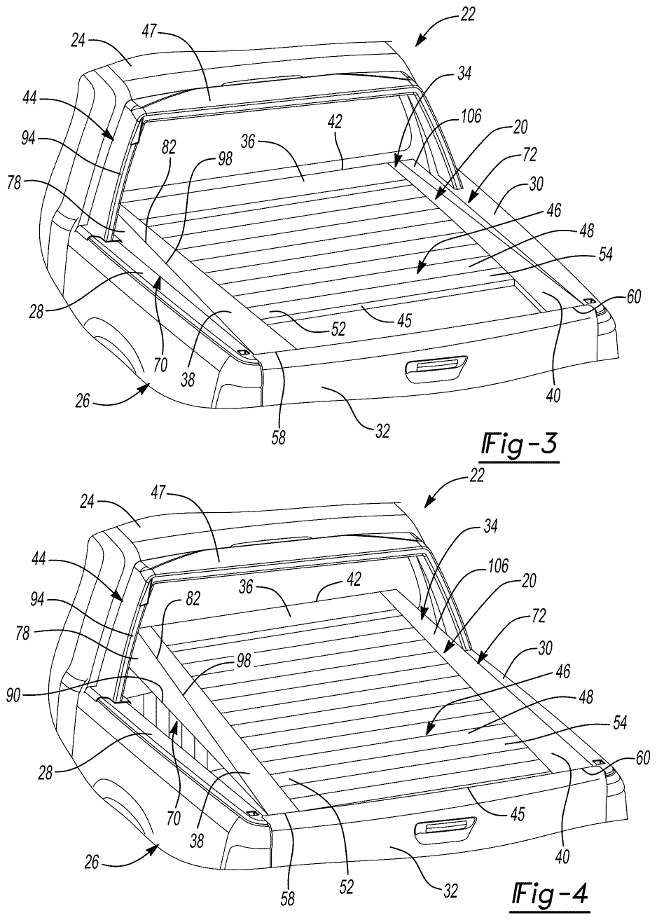

With reference to FIGS. 1-6, a tonneau system 20 is shown coupled to an exemplary vehicle 22. Tonneau system 20 is moveable between an aerodynamic position depicted in FIG. 1 and a horizontal position depicted in FIG. 3. Vehicle 22 includes a cab 24 as well as a cargo bed 26 including side walls 28, 30 and a tailgate assembly at reference numeral 32.

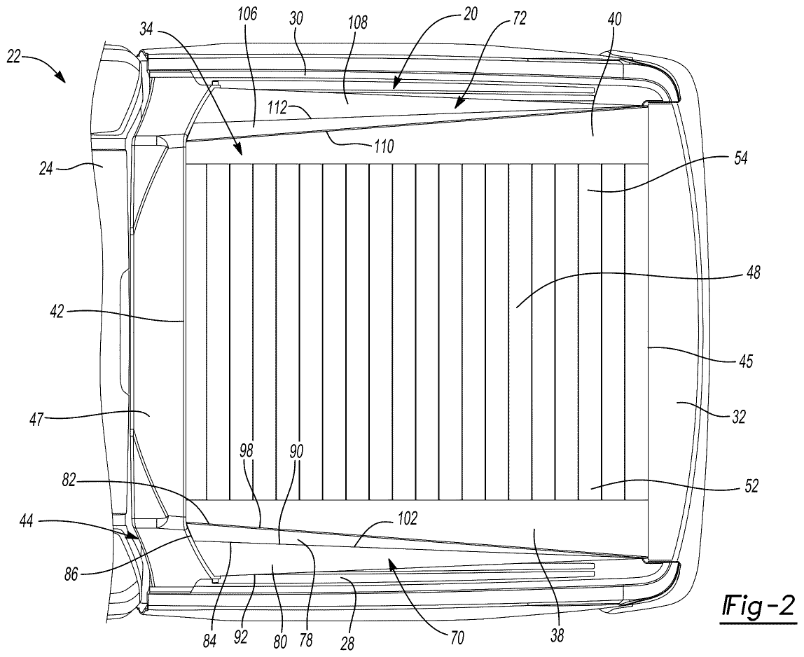

Tonneau system 20 includes a frame 34 including a header 36, a first rail 38, and a second rail 40. Frame 34 is sized and shaped to correspond to fit within cargo bed 26. First rail 38 is positioned proximate to but spaced from side wall 28. Second rail 40 is positioned proximate to but spaced apart from side wall 30. Header 36 is positioned at a leading edge 42 of tonneau system 20 proximate to cab 24. In the embodiment depicted in FIGS. 1-6, first rail 38 and second rail 40 have trapezoidal shapes in the top view as shown in FIG. 2. This need not be the case in all embodiments.

Vehicle 22 or tonneau system 20 may include an optional accessory bar 44 coupled to cab 24. Accessory bar 44 may be coupled to side walls 28, 30. Accessory bar 44 may be configured as a variety of alternate structures including a roll bar or a light bar. A trailing edge 45 of tonneau system 20 is positioned adjacent to tailgate 32 and pivotally coupled to vehicle 22. The elevation of trailing edge 45 does not change when tonneau system 20 moves from the horizontal position to the aerodynamic position. At the aerodynamic position, leading edge 42 is positioned adjacent to or proximate to an upper crossbar 47 of accessory bar 44.

Tonneau system 20 includes a retractable cover 46 slidingly coupled to frame 34. It is envisioned that cover 46 may be constructed using a variety of different components. In a first arrangement, cover 46 includes a plurality of transversely extending slats 48. Slats 48 are positioned adjacent to one another and coupled to a membrane or backing panel (not shown). FIGS. 1 and 2 depict cover 46 in a deployed position enclosing cargo bed 26. Each of slats 48 includes a first end 52 and an opposite second end 54. Each first end 52 of each slat 48 is positioned within a groove 58 formed on first rail 38. Similarly, each second end 54 of each slat 48 is positioned within a groove 60 of second rail 40. Grooves 58, 60 act as guides defining the position of slats 48.

In an alternate arrangement, cover 46 is constructed as a one-piece monolithic member including a plurality of panel portions interconnected by a relatively thin web of material. The relatively thin web of material acts as a living hinge allowing the cover to move between the deployed position and a retracted position.

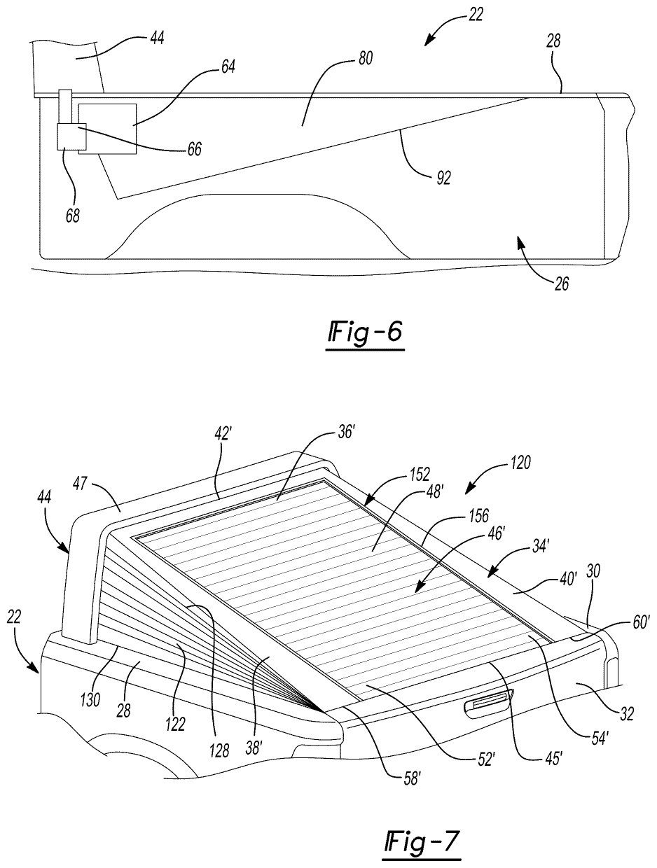

Tonneau system 20 may include a cartridge 64 coupled to vehicle 22. Cartridge 64 is shaped as a hollow housing having an opening 66 as depicted in FIG. 6. Cover 46 is moveable between the deployed position shown in FIGS. 1 and 2 and the retracted position where a majority, if not all, of slats 48 are positioned within cartridge 64. In the retracted position, cover 46 may be rolled in a spiral shape or slats 48 may be positioned within cartridge 64 in a stacked arrangement. FIG. 3 depicts cover 46 in an intermediate position between the retracted and deployed positions. A retraction mechanism 68 may be present to assist a vehicle operator with moving cover 46 between positions. Retraction mechanism may include an electric motor, springs, or any other suitable arrangement.

A drive mechanism (not shown) movably interconnects frame 34 with vehicle 22. The drive mechanism is operable to move frame 34 and cover 46 between the horizontal position depicted in FIG. 3 and the aerodynamic position depicted in FIG. 1. The drive mechanism may be manually operated or may include one or more electrically or hydraulically powered machines to reposition the tonneau cover.

After moving frame 34 and cover 46 from the horizontal position to the aerodynamic position, it may be desirable to enclose the triangularly shaped openings between the side walls 28, 30 and frame 34. As best shown in FIGS. 1 and 2, tonneau system 20 includes a moveable first side panel 70 and a moveable second side panel 72. First side panel 70 and second side panel 72 are coupled to frame 34 and deployable between retracted and extended positions.

First side panel 70 includes a first portion 78 and a second portion 80. First portion 78 is triangularly shaped and includes a first edge first portion 78 is triangular shaped and includes a first edge 82, a second edge 84, and a third edge 86. Second portion 80 includes a first edge 90, a second edge 92, and a third edge 94. First portion 78 is pivotally coupled to frame 34. More particularly first edge 82 of first side panel 70 is coupled to first rail 38 of frame 34 with a hinge 98. Hinge 98 may be formed as several spaced apart hinges or as a singular elongated piano hinge.

Second portion 80 is pivotally coupled to first portion 78. First and second portions 78, 80 are positioned adjacent to one another and pivotally coupled to one another at a joint 102. Joint 102 may include a separate component such as a piano hinge or joint 102 may be formed as a living hinge with first portion 78 and second portion 80 being parts of a one-piece monolithic component. First portion 78 is shaped as a substantially planar rigid wall. Second portion 80 is also shaped as a substantially planar rigid wall.

When tonneau system 20 is at the aerodynamic position, first portion 78 and second portion 80 are disposed at substantially upright positions. Third edge 86 of first portion 78 and third edge 94 of second portion 80 are sealingly engaged with accessory bar 44. Second edge 92 of second portion 80 is sealed against side wall 28. Frame 34 is also sealed to accessory bar 44 when tonneau system 20 is at the aerodynamic position.

It should be appreciated that second side panel 72 is substantially the mirror image of first side panel 70. Second side panel includes a third portion 106 and a fourth portion 108. Third portion 106 is pivotally coupled to second rail 40 with a hinge 110. Third portion is pivotally couple to fourth portion 108 at a joint 112. The remaining geometrical features and functions of second side panel 72 are substantially the same as previously described in relation to first side panel 70. In the interest of brevity, a repetitive description will not be provided.

FIG. 3 depicts tonneau system 20 in the horizontal position. At this time, frame 34, cover 46, first portion 78 of first side panel 70 and third portion 106 of second side panel 72 lie along the same plane substantially parallel to the ground and substantially parallel to upper surfaces of side walls 28, 30. FIG. 3 shows cover 46 at an intermediate position between the deployed and retracted positions.

FIG. 4 shows tonneau system 20 at an intermediate position between the horizontal position depicted in FIG. 3 and the aerodynamic position depicted in FIG. 1. First portion 78 of first side panel 70 and third portion 106 of second side panel 72 are in an upright position no longer parallel to cover 46. Second portion 80 of first side panel 70 is not in view in this figure as it is tucked beneath frame 34 and cover 46.

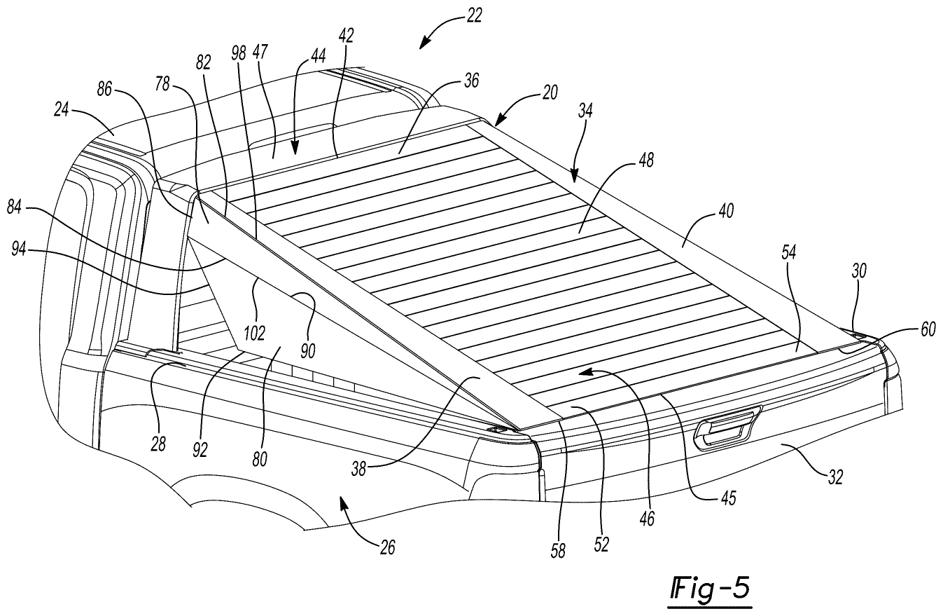

FIG. 5 depicts frame 34 and cover 46 at the aerodynamic position. First portion 78 of first side panel 70 is at an upright position and second portion 80 of first side panel 70 is temporarily disposed at an intermediate position. As previously noted, FIGS. 1 and 2 show tonneau system 20 at the aerodynamic position including the entirety of first side panels 70 and second side panel 72 in their upright positions. As depicted in FIGS. 1 and 2 and as previously described, certain edges of first side panel and second side panel 72 are sealingly engaged with accessory bar 44 and side walls 28,30.

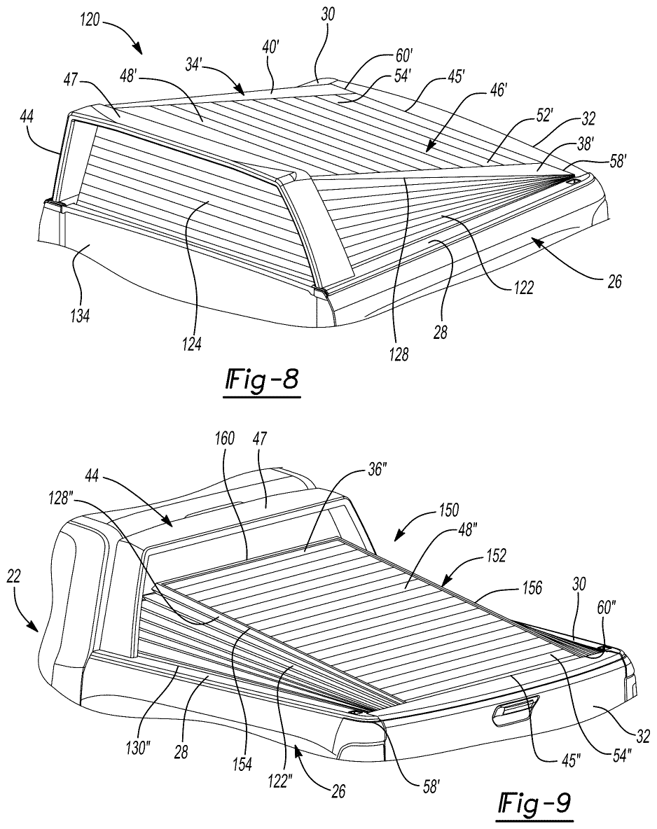

FIGS. 7-8 depict an alternate embodiment tonneau system 120. Tonneau system 120 is substantially similar to tonneau system 20. Accordingly, similar elements will be identified with like reference numerals including a prime suffix. The majority of the differences between tonneau system 20 and tonneau system 120 relate to a first side panel 122 and an opposite second side panel (not shown). Second side panel is substantially the mirror image of first side panel 122. Tonneau system 120 also includes a third panel 124 as shown in FIG. 8. First side panel 122, the second side panel, and third panel 124 are constructed from a flexible material that is extendable when frame 34′ moves between the horizontal position and the aerodynamic position and collapsible when moving in the opposite direction.

In the embodiment shown in FIGS. 7 and 8, each of first side panel 122, the second side panel and third panel 124 include a plurality of pleats that fold upon one another in a similar fashion to an accordion to allow the panels to expand when raised and collapse or shrink when lowered. Tonneau system 120 exhibits excellent sealing characteristics as an upper edge 128 of first side panel 122 is sealed and fixed to first rail 38′. A second edge 130 of first panel 122 is sealed and fixed to side wall 28 of vehicle 22. In similar fashion, third panel 124 is sealed and fixed to an end cap 134 of cargo bed 26. Third panel 124 may also be sealed and fixed to accessory bar 44. Frame 34′ is substantially similar to frame 34. It includes trapezoidally shaped first rail 38′ and a second rail 40′. It should be appreciated that the second side panel is similarly attached to the vehicle and the frame as described in relation to first side panel 122. While the side panels and the front panel of tonneau system 120 have been depicted and described as including pleats having an accordion shape, it is within the scope of the present disclosure to utilize side panels and a front panel that are flexible in nature but do not include a pleated structure. It is also contemplated that first side panel 122, the second side panel, and third panel 124 may be integrally formed as a one-piece monolithic component.

Another alternate embodiment tonneau system is depicted in FIG. 9 and identified at reference numeral 150. Tonneau system 150 is substantially similar to the previously described tonneau systems with the exception that a frame 152 includes a rectangular shape with a first rail 154 extending substantially parallel to an opposite second rail 156. As such, like elements will retain their previously introduced reference numerals including a double prime suffix. A header 160 transversely extends and intersects first rail 154 and second rail 156 at right angles. Once again, even though FIG. 9 is depicted having a pleated first side panel 122″, it is within the scope of the present disclosure to construct side panels and an end panel (not shown) of flexible materials that may collapse and expand to accommodate the pivoting movement of frame 152 between horizontal and aerodynamic positions. It is alternatively contemplated to incorporate the previously described first side panel 70 and second side panel 72 with the arrangement and frame configuration depicted in FIG. 9.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tonneau system for a vehicle including a cargo bed, comprising:
a frame including a leading edge and a trailing edge;
a cover coupled to the frame and moveable between a deployed position and a retracted position;
a first side panel; and
an opposite second panel,
wherein the frame is moveable between a horizontal position and an aerodynamic position, wherein at the horizontal position, the frame extends substantially parallel to the ground at a first elevation, wherein the leading edge of the frame is positioned a second elevation higher than the first elevation and the trailing edge remains at the first elevation when the frame is at the aerodynamic position,
wherein the first side panel includes a first portion pivotally coupled to the frame and a second portion pivotally coupled to the first portion, the first portion extending substantially parallel to the ground when the frame is at the horizontal position, the first portion extending upright when the frame is at the aerodynamic position to close an opening that forms between the frame and the vehicle when the frame is at the aerodynamic position.

2. The tonneau system of claim 1, wherein the first portion is positioned adjacent to and coplanar with the frame when the frame is at the horizontal position.

3. The tonneau system of claim 1, wherein the second portion is upright and includes an edge in sealing contact with the vehicle when the frame is at the aerodynamic position.

4. The tonneau system of claim 1, wherein the second portion is upright when the frame is at the horizontal position, the second portion being disposed close to the ground than the first portion.

5. The tonneau system of claim 1, further comprising a retraction mechanism operable to move the cover between deployed and retracted positions.

6. The tonneau system of claim 1, wherein the cover includes a plurality of transversely extending slats coupled to the frame.

7. The tonneau system of claim 1, further comprising a cartridge in receipt of a majority of the cover when the cover is in the retracted position.

8. The tonneau system of claim 1, wherein the first side panel is a one-piece monolithic component.

9. The tonneau system of claim 1, wherein the frame includes a first rail and a second rail, the first and second rails each having a trapezoidal shape.

10. The tonneau system of claim 9, wherein the first portion has a triangular shape complementing the trapezoidal shape of the first rail when the frame is at the horizontal position.

11. A tonneau system for a vehicle including a cargo bed, comprising:
a frame including a leading edge and a trailing edge;
a cover coupled to the frame and moveable between a deployed position and a retracted position;
a flexible first side panel;
a flexible second panel; and
a flexible third panel,
wherein the frame is moveable between a horizontal position and an aerodynamic position, wherein at the aerodynamic position the leading edge of the frame is positioned at an elevation higher than the trailing edge,
wherein the first side panel, the second panel, and the third panel are fixed to the frame, the first, second and third side panels being compressed when the frame is at the horizontal position and being extended when the frame is at the aerodynamic position.

12. The tonneau system of claim 11, wherein the first side panel, the second panel, and the third panel are sealingly coupled to the vehicle.

13. The tonneau system of claim 11, wherein the first side panel is pleated.

14. The tonneau system of claim 11, further comprising a retraction mechanism operable to move the cover between deployed and retracted positions.

15. The tonneau system of claim 1, wherein the cover includes a plurality of transversely extending slats coupled to the frame.

16. The tonneau system of claim 1, further comprising a cartridge in receipt of a majority of the cover when the cover is in the retracted position.

17. The tonneau system of claim 1, wherein the first side panel, the second panel, and the third panel are formed as a one-piece monolithic component.
